(19) United States
(12) Patent Application Publication
(10) Pub. No.: US 2008/0243745 A1
(43) Pub. Date: Oct. 2, 2008

(54) Human Level Artificial Intelligence Software Application for Machine & Computer Based Program Function

(76) Inventor: Mitchell Kwok, Honolulu, HI (US)

Correspondence Address: Mitchell Kwok, 1675 Kamamalu ave., Honolulu, HI, 96813, US

(21) Appl. No.: 11/744,767

(22) Filed: May 4, 2007

Related U.S. Application Data
(60) Provisional application No. 60/909,437, filed on Mar. 31, 2007.

(51) Int. Cl. G06N 5/02

(52) U.S. Cl. 706/46

(57) ABSTRACT

A method of creating human level artificial intelligence in machines and computer software is presented here, as well as methods to simulate human reasoning, thought and behavior. The present invention serves as a universal artificial intelligence program that will store, retrieve, analyze, assimilate, predict the future and modify information in a manner and fashion which is similar to human beings and which will provide users with a software application that will serve as the main intelligence of one or a multitude of computer based programs, software applications, machines or compilation of machinery.

### CROSS REFERENCE TO RELATED APPLICATIONS

This application claims the benefit of U.S. Provisional Application No. 60/909,437, filed on Mar. 31, 2007, entitled: Human Level Artificial Intelligence Software Application for Machine & Computer Based Program Function.

### STATEMENT REGARDING FEDERALLY SPONSORED RESEARCH OR DEVELOPMENT

(Not applicable)

### BACKGROUND OF THE INVENTION

1. Field of the Invention

This invention relates generally to the field of artificial intelligence. Moreover it pertains specifically to human level artificial intelligence for machines and computer based software.

2. Description of Related Art

For 60 years, ever since artificial intelligence has been around, scientists have long to build a machine that can think, reason, behave, and act like a human being. The problem with current AI software is that they cater to parts of human intelligence and not human intelligence as a whole. This is why there are so many subject matters related to artificial intelligence.

One aspect is the fact that no one has defined what the conscious is? The conscious is highly debated by both psychologists and AI researchers. In order to build a human brain the conscious must be defined. This would include: what the conscious is, how does the conscious work, and what are the computer codes to implement the software to a conscious?

Building a network that will store, retrieve, and modify information is another aspect that must be considered. The internal data in neurons and how the dendrites work has baffled many AI researchers. Neural networks try to resemble how neurons work but there are many unanswered questions with those AI programs and they don't work very well. The growing problem of how does the data get stored in memory and how does the data get retrieved by the host is still a mystery. What exactly are the data stored in the neurons is also something that has never been explained.

Another aspect is the field of reasoning and probability in machines. Currently, Bayesians probability theories, semantic networks, discrete mathematics, and language parsers are used in combination to produce a machine that can learn language/knowledge in a limited environment. The idea was to build something that can learn and understand language and to use the language to make the machines learn things from its environment. However, this is complicated by the fact that it is very difficult to build a machine that can learn language using the current AI methods. Even language that a 5 year old is capable of learning is very difficult to do in machines.

### SUMMARY OF THE INVENTION

To solve the mentioned problems above, the present invention proposes a totally different way of building a human robot. This would include defining/building a conscious, building a network to store/retrieve/modify large amounts of information, building a machine that can learn language and common sense knowledge, and building a machine that can learn probability and reasoning. In addition to this, the invention not only has the capability of human intelligence but the capability to acquire intelligence that “exceeds” human intelligence.

There are thousands of ways of building a human brain. This human level artificial intelligence program is a collection of 6 years of designing and implementing a software that I think will produce human intelligence. The HLAI program is a computer brain that can predict the future. The AI software can be applied to all machines and the machine will behave intelligently at or similar to human intelligence. If the human level AI is applied to a car then the car will drive by itself from one location to the next in the safest and quickest way possible. If the HLAI is applied to a plane then the plane will fly by itself from one place to the next in the safest and quickest way possible. If the HLAI is applied to a videogame then the AI can play any game for that videogame system. Just like humans, the AI program uses knowledge from the past to predict what will eventually happen in the future. By giving the AI the ability to see into the future it can anticipate what will eventually happen next and take the best course of action.

A camera is used to interface the HLAI program with all the different machines. The program will store all the frame-by-frame video in memory in an organized way. My program can store large amounts (almost infinite) hours of video in memory and the retrieval program will get the video clips in a quick way using multiple search points. This is revolutionary because it would mean that the computer will never run out of disk space (current neural networks can't do this). The program also self-organizes all the data in memory so that common video clips will be stored in the same area. The storage part of the program works by storing each frame of the movie in a 3-d environment. The result is the 3-d representation of all the movies. The 3-D environment is actually the average of all the movies stored in memory. Theoretically, this is how humans store information in memory

The idea behind the memory of the AI is to store the most important pathways (movie sequences) and to forget the least important pathways. The network uses strength of node/s to represent any repeated data. The more a pathway is trained the stronger the node/s become. The less training it goes through the less strength the node has. The length of the pathway also grows with more training and the length of the pathway shrinks with less training.

The present invention is novel because it solves 80 percent of all problems facing the field of artificial intelligence. Some of the features that are novel in the present invention are:
A. The AI can learn common sense knowledge and language without language parsers, discrete mathematics, semantic networks, probability theories, or any type of modern day AI technique/s.
B. The AI is capable of learning what is known as universal language. Instead of limiting the language to English the AI can learn Chinese, German, Arabic, Korean, Dutch, Spanish, French or any language, even alien language.
C. It can store large, “almost infinite”, amounts of video or pictures and the data can be retrieved quickly.
D. In prior art, storing all possible outcomes of a 2-player game in memory is impossible. The total possible outcome of a chess program is 10 to the 40^{th} power and the total combinations of the outcome are infinite. My program can store all the possible outcomes of a chess program (which amounts to infinite data). A more complex form of the chess program is movie sequences from real life or videogames. My program can store the total possible outcomes of movie sequences as well.
E. In prior art, the majority of 2-player AI games such as chess, and checkers use expert systems to calculate future steps during runtime. My program stores all the possibilities in memory and uses the stored data to predict the future (given that a 100 percent pathway match is found in memory). My program uses fuzzy logic to predict the future for similar or non-existing pathways in memory.
F. There is no need to insert rules into the network because the rules are learned through training. If you apply this program to a car, all the rules of driving are learned by observation. An expert trainer has to drive the car and the AI must observe, store and average all the training data in memory. When the data is averaged out the AI will understand the rules of driving.
G. The method the AI uses to retrieve information is faster than any search algorithm in computer science. The timing of the search is considerable lessoned as more data gets inserted into the network.
H. No modern day AI technique is used to learn probability and reasoning. The AI learns probability and reasoning through patterns. I set up the different patterns in the system and the AI finds these patterns.
I. The HLAI program is versatile and can be applied to all machines including: cars, trucks, buses, planes, forklifts, computers, human robots, houses, lawnmowers, radios, phones, and even toaster ovens. “All” machines can be hooked up to the HLAI and that machine will act intelligently at or above human intelligence.
J. The HLAI has no boundaries as to its application. It not only is a revolutionary technology applied to computer science, but other disciplinary fields such as biotechnology, engineering, aero dynamics, chemistry, medicine, genetic engineering, and mathematics. The novel things that can be created from this invention are: a software that can predict an earthquake or hurricane one year in advance, a humanoid robot, a machine that can predict the future and the past with pinpoint accuracy, automated software to do all human jobs including: driving, surgery, retail, technical tasks, operating cameras for movies and tv, hair cuts, make-up, construction, building houses, fighting a war and so forth. Anything that a human or a group of humans can do this invention will also be able to do.

### BRIEF DESCRIPTION OF THE DRAWINGS

For a more complete understanding of the present invention and for further advantages thereof, reference is now made to the following Description of the Preferred Embodiments taken in conjunction with the accompanying Drawings in which:

FIG. 1 is a software diagram illustrating a program for human level artificial intelligence according to an embodiment of the present invention;

FIG. 2 is the software diagram of the present human level artificial intelligence program presented in a different way.

FIG. 3 a diagram depicting self-organization of data in memory.

FIG. 4 depicting the current pathway during each iteration of the for-loop in FIG. 1.

FIG. 5 a diagram demonstrating how conscious thoughts are used to interpret grammar.

FIG. 6 a diagram depicting the data structure of memory.

FIG. 7 a flow diagram depicting the searching of data from FIG. 6.

FIG. 8 illustrates the search process.

FIG. 9 a diagram to illustrate the searching process using both commonality groups and learned groups.

FIGS. 10-11B diagrams demonstrating sequential connections and encapsulated connections.

FIG. 12 a diagram of 2-d data structured trees representing conventional networks, hashtables, vectors, or linklists.

FIG. 13 a diagram of 3-d data structure for the present invention.

FIG. 14 diagrams showing the weights of sequential connections and encapsulated connections.

FIGS. 15A-15B diagrams depicting the rules program.

FIG. 16 a diagram to demonstrate how the rules program assigns meaning to sentences.

FIGS. 17-18 illustrations to demonstrate image layers.

FIGS. 19-20 illustrations to demonstrate how the rules program assign meaning to nouns and verbs.

FIGS. 21A-21B diagrams to illustrate how the mind produces conscious thoughts.

FIGS. 22-24 illustrations to demonstrate the 4 deviation functions.

FIGS. 25-27C diagrams illustrating examples of how the present invention can demonstrate human intelligence.

### DESCRIPTION OF THE PREFERRED EMBODIMENTS

The Human Level Artificial Intelligence program acts like a human brain because it stores, retrieve, and modify information similar to human beings. The function of the HLAI is to predict the future using data from memory. For example, human beings can answer questions because they can predict the future. They can anticipate what will eventually happen during an event based on events they learned in the past.

There are multiple parts to the program:
A. storage of data
B. retrieval of data
C. the rules program (or self-organization of data)
D. future prediction
   All these parts of the program work together to produce the intelligence of the machine. I will outline each of the parts individually and try to link them together. The next several paragraph explains how all the parts work together to form the intelligence of the machine.

The present invention provides a method of creating human level artificial intelligence in machines and computer based software applications, comprising: the AI program repeats itself in a single for-loop to receive information, calculate an optimal pathway from memory, and taking action.

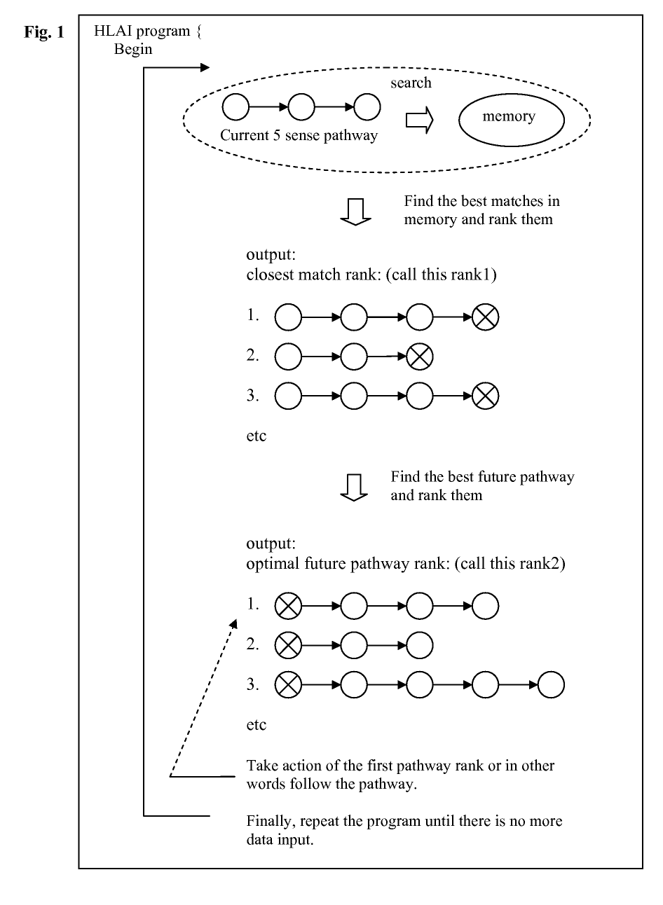

First, the AI will get input (current pathway) from the environment. Next, the AI uses the search function to find the optimal pathway from memory. The optimal pathway is based on two criteria: the best pathway matches and best future predictions. The input data (current pathway) will be stored in the optimal pathway. The rules program, the self-organizing of data and the pattern finding are all done at the time the data is stored in memory. When all the data is stored, the AI will follow the future pathway of the optimal pathway. Finally, the program repeats itself from the beginning (FIG. 1).

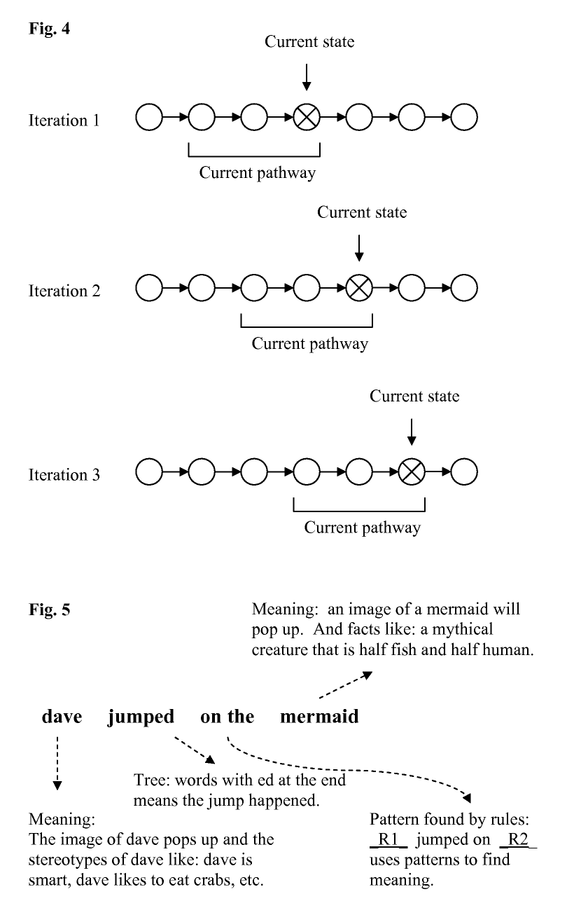

The length of the input will be defined by the programmer. In (FIG. 4) the length of the input, or the current pathway, is 3 frames. During each iteration of the for-loop the AI receives one extra frame from a camera and this frame will be attached to the front of the current pathway; designated as the current state. The last frame of the current pathway will be deleted. The current pathway will be the fixed pathway searched in memory at each iteration of the for-loop.

Storage

Human beings store information in terms of a movie. If that person lives for 10 years then the brain has to store 10 years worth of video. If that person lives for 1 thousand years then the brain has to store 1 thousand years of video. The purpose of the storage is to collect large amounts of movies and store them in a way that will minimize repeated data and prevent memory overload. The current neural networks or compression programs can't do this. My HLAI can store large amounts of movies in a network where all the data are interconnected.

Data is stored in terms of a movie—frame by frame. The things that can be stored in the frames can range from images to sound to other senses such as taste, touch, and smell. I call these data, objects, because they can be “anything”. An object can be a dog barking or a blue pencil or a letter. Objects can also be encapsulated such as a hand is one object that is encapsulated in another object, the arm. Objects can also be combined. One example is the sound of a car zooming by and the images of the car moving. (When I mention words such as: pathways, data, information, and movie sequences I'm referring to objects)

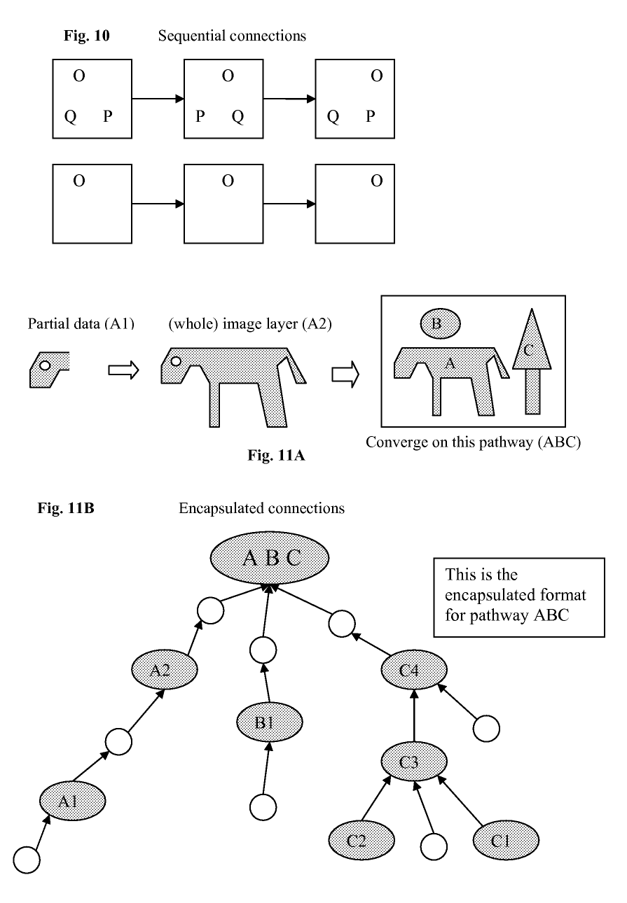

For each data in memory there are two types of connections: sequential connections and encapsulated connections. Both types of connections are independent of one another but are used to connect data in the same storage space. The sequential connections are shown in (FIG. 10), where each arrow represents a sequential connection. Data are stored in the frames and the data can be anything. On the bottom (FIG. 11B) is a diagram of encapsulated connections. These are connection points that states that one object (data) is encapsulated in another object (data). The AI will be using the sequential connections to predict the future and the AI will be using the encapsulated connections for storing and retrieving information from the network (FIG. 14).

As the AI learns knowledge from the environment the weights of the connections (for both connection types) will get stronger and stronger. In some cases the connections get weaker and weaker based on external factors such as pain or pleasure. When data is repeated the data gets stronger. When data is unique and new it is created. As time passes the data that aren't trained often will be deleted from the network and data that are trained often is kept in the network. This is similar to how humans remember things. The most important information is kept in memory while the minor information is deleted.

Data in memory are also organized into two groups: commonality groups and learned groups. The commonality groups are the groups that have some form of common physical trait. A man and a women have common traits. Although they are different they both have 2 arms, two legs, and 1 head. The learned groups are groups that are learned to be the same. For example, a horse and a pig look absolutely different. However, they are both animals. The word animal is the learned group for both the horse and the pig.

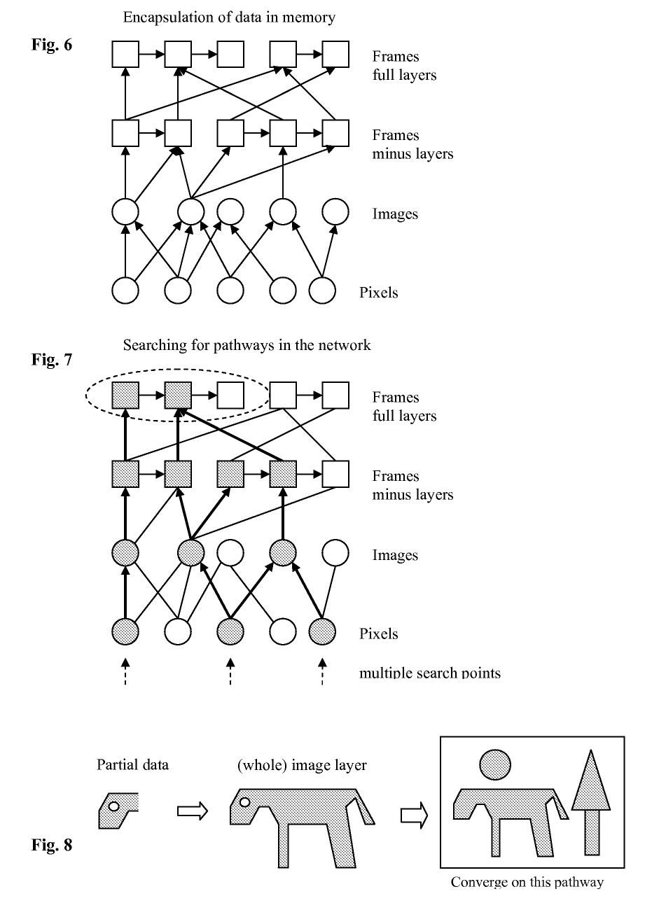

Both the learned groups and the commonality groups must co-exist in the same storage space. All the data are also encapsulated within these two groups. In memory, anything that has similar traits to each other will be grouped and brought closer together. This is how the data in the network are interconnected and each data is connected to other data in the network globally. An example of this is from the diagram (FIG. 6). This diagram displays the level of encapsulation for visual images and movies. The lowest level will be the pixels. The pixels are encapsulated in the images. Next, the images are encapsulated in the frames. Finally, the frames are encapsulated in the movies.

In the current neural networks, when data is inserted into memory, every data in the network must be modified. This can waste a lot of disk space and computer processing time. The HLAI program on the other hand only changes specific data in memory but at the same time preserve the fact that the network is interconnected. The secret is that when the AI stores a pathway in memory it looks at its neighbors to find if there are any commonality and learned groups nearby. When and if the AI finds common groups it will bring those data with the same group closer together. If two identical nodes are close enough they will merge into one and this will free up disk space. The new nodes will be created and connected to existing nodes in the network (FIG. 3).

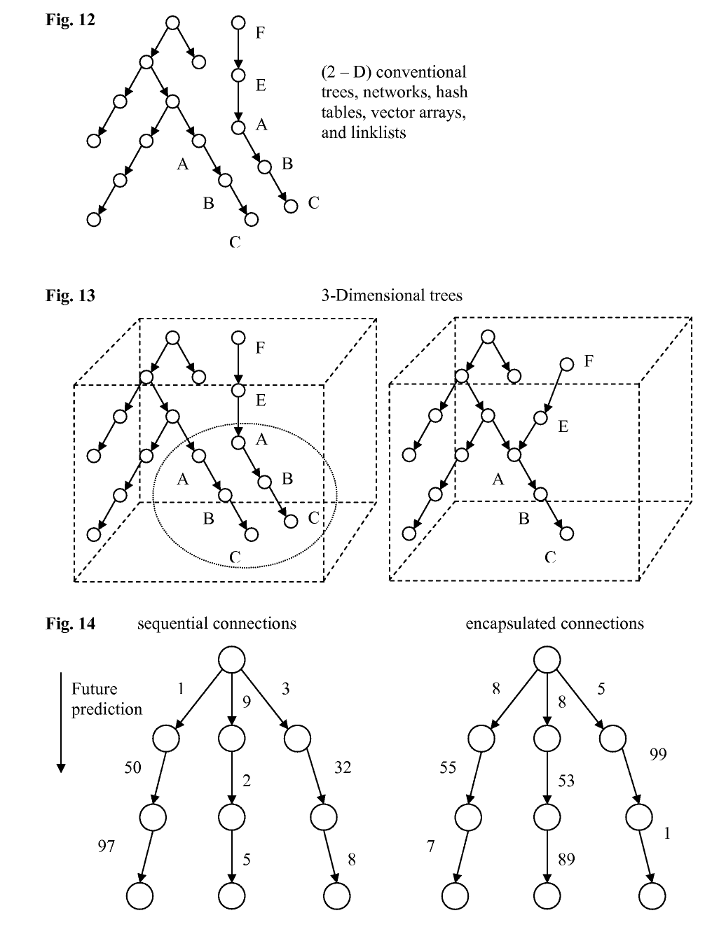

In terms of the topology of storage, data will be contained in a 3-dimensional grid where the movie pathways are stored as trees or branches of trees. In (FIG. 12), the conventional way of building trees, networks, hash tables, vector arrays, or linklists will not work. Most of the data structures used today store information in one fixed tree with one fixed starting point. This would mean that in order to store information the tree has to be traversed from a fixed point and stored in its appropriate area. In (FIG. 12) the relationship between elements A B C in the first tree will not have any relationship to A B C on the second tree and can not be brought closer together.

In a 3-dimensional grid the trees do not have a fixed point to start from nor does it require traversing the tree to store information (FIG. 13). The data is not stored in one tree but multiple trees that grow in size and length. Data in memory can shrink because data can be forgotten or it can grow if new data is inserted. Sections of long trees can be broken up into sub trees or it can migrate from one part of memory to another part of memory (this process is slow because the network needs time to adequately self-organize data and to preserve the global data connections).

One advantage of 3-d storage is that the AI can store pathways anywhere in the 3-d space without having to search and identify items from a fixed point. All the trees and all the branches of the trees can be easily retrieved by the search algorithm discussed below.

Another advantage of 3-d storage is that the AI can bring branches of trees together without traversing the branches of the trees. In (FIG. 13) the AI will bring commonality traits of all the branches of the trees that fall within a given radius. A,B,C are the common traits. Any data that is contained in the radius will be subject to self-organization, while data outside of the radius will not be affected. This will bring relations between data closer together where the data can self-organize itself only in specific areas. This will also preserve the fact that all data in the network are interconnected in a global manner.

The movie pathways are stored and arranged in memory based on their sequences. This will create a 3-d environment using the 2-d movie frames. Although the movie will have many variations, many temporary objects, and many object layers, the function of self-organization will knit all the data in memory together. Anything that is stationary is more likely to have a permanent place in memory, while objects that move a lot is temporarily stored. After averaging out all the data, the 3-d environment will be established first because the majority of our environment stays the same. Things like pedestrians, moving cars, and non-stationary objects are forgotten. The 3-d environment is considered one big floater because it has a fuzzy range of itself—the environment can be day or night or rainy or damaged and so forth but because it falls within the floater's fuzzy range it will still be identified as the environment (floaters will be discussed shortly).

Retrieval of Data in the Network

The purpose of retrieving data from memory is to find one pathway, the optimal pathway, that best matches the current pathway.

For retrieving data from memory, the strength of each data's encapsulated connections in memory has already been established based on training (FIG. 14). Searching for data is accomplished by following the strongest encapsulated connections. This means that if the AI receives partial data of an image it will follow the strongest encapsulated connections to get the full data of an image.

Retrieving data from the network will require multiple search points. The AI will randomly pick out search points in the network. These search points will communicate with each other during the search process to find the data that it is looking for. This form of searching for information is faster than any search algorithm in computer science because it uses multiple search points along with a form of fuzzy logic to get information. This searching of data is kind of like throwing ants randomly in a room. At the center of the room is a piece of candy. As the ants searches for the candy they will communicate with each other to find the candy. When one ant finds the candy all the other ants know where the candy is located.

Each search point will communicate with other search points on search results such as successful searches, failed searches, best possible searches and unlikely possible searches. Each search point has a priority number, and determining the priority number depend on these criteria: the more search points that merge into one search point the higher the number, the more matches found by the search point the higher the number, and the more search points surrounding that search point the higher the number. The higher the priority number the more computer processing time is devoted in that search point and the lower the priority number the less computer processing time is devoted in that search point.

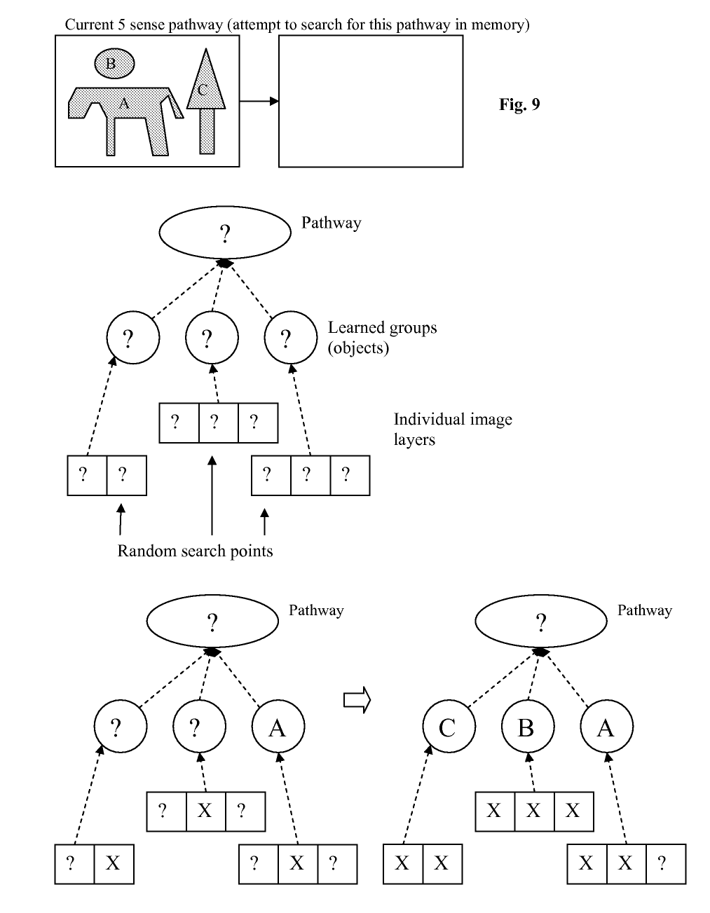

The retrieval of data uses both the commonality groups along with the learned groups to find information. The learned groups use the top-down search method and the commonality groups use the bottom-up search method. Both the bottom-up search method and the top-down search method will be used to search for information. In (FIG. 7) the search is done using commonality groups. In (FIG. 9) the search is done with both commonality and learned groups.

First, the AI breaks up the current pathway into sections. The current pathway is the pathway the AI is currently experiencing. The image processor will guide the process of breaking up the data into sections. Each section will be searched in memory based on randomly spaced out search points. All searches are done by traveling on the strongest encapsulated connections. Each search point will communicate with other search points on possible good searches or failed searches. The search points will merge together when they have the same search results and their priority number will be combined. The better the search result the more search points will be in that area. This will happen throughout all the search points until they converge on a match for the current pathway. If the current pathway isn't found in memory the AI will find the closest match.

The learned groups are used in the search process to find data even faster because they can tell the search points what are continuous frames and what aren't continuous frames. For example, if a search point finds one cat image in memory then the image sequence of the cat is also found in memory because visual images are stored in a 3D environment. In (FIG. 9) the X marks the individual search points. These search points are known as partial data. The purpose of the search points is to find the whole data. Each search point will follow the strongest encapsulated connected nodes to find better matches. Once the whole data is found it will tap into the whole data's learned group. In this example “A” represent horse, “B” represent the sun, and “C” represent a tree. The whole data is the visual image of the horse. Partial data is the visual head of the horse. When the whole image of horse is found, that image has a learned group, the word “horse”. Once the learned group “horse” is identified then all the sequential images of horse from the current pathway will also be identified. This process will repeat itself for A, B and C. The search points will keep trying to find better and better matches until the entire network is searched.

When the AI locates the optimal pathway (or the best pathway match) in memory that is where the current pathway will be stored. But before that can happen a process of breaking down the current pathway into its encapsulated format must be done. This process consumes a lot of disk space but is necessary to preserve the global network. In (FIGS. 11A and 11B) the AI breaks down the current pathway into its encapsulated format based on the pathways the search function took to find the optimal pathway. This means that pathways that lead to the optimal pathway are used to break down the input data into its encapsulated parts. Once the encapsulated format is created for the current pathway, new data will be created and stored in its respective area while data already in the network will be strengthened.

In (FIG. 11B) the current pathway is broken up into objects A, B, and C. Then it further breaks down the objects into its encapsulated objects. Things that make up that object, most notable the strongest objects, will be broken down. This process will go on and on until the individual pixels. If this takes up too much disk space and computer processing time the programmer can define how far the AI can break down the images. For example, break down images until the pixels are made up of groups of 6.

However, understand that the data in memory forgets. Several hours after the new data is inserted into memory, half of the data will be forgotten. If the data is trained many times it will stay in memory permanently, while data that happens coincidentally will stay in memory temporarily.

The Rules Program

Objects

Objects can be anything. It can be sound, it can be vision, it can be touch, and so forth. A visual word can be an object, a sound of a word can be an object, or the visual meaning of the word can be an object. For different senses the objects can be represented differently. There is also the consideration of combinations of objects together such as a visual object in conjunction with a sound object. A car zooming by is a combination of a visual object and the zoom sound is the sound object. Or dropping a pencil on the ground is a combination of visual and sound objects.

Another factor is that objects can be encapsulated. For example, a hand is an object that is encapsulated in another object, a human being. Another example is a foot is an object encapsulated in another object, a leg.

The way the program learns these objects is by repetition and patterns. Each object is represented by strength and if it ever repeats itself the strength gets stronger. If the object don't repeat itself then it will forget and memory won't have a trace. 1-d, 2-d, 3-d, 4-d, and N-d objects can be created by repetition and patterns.

Object Association is the Key to the Conscious

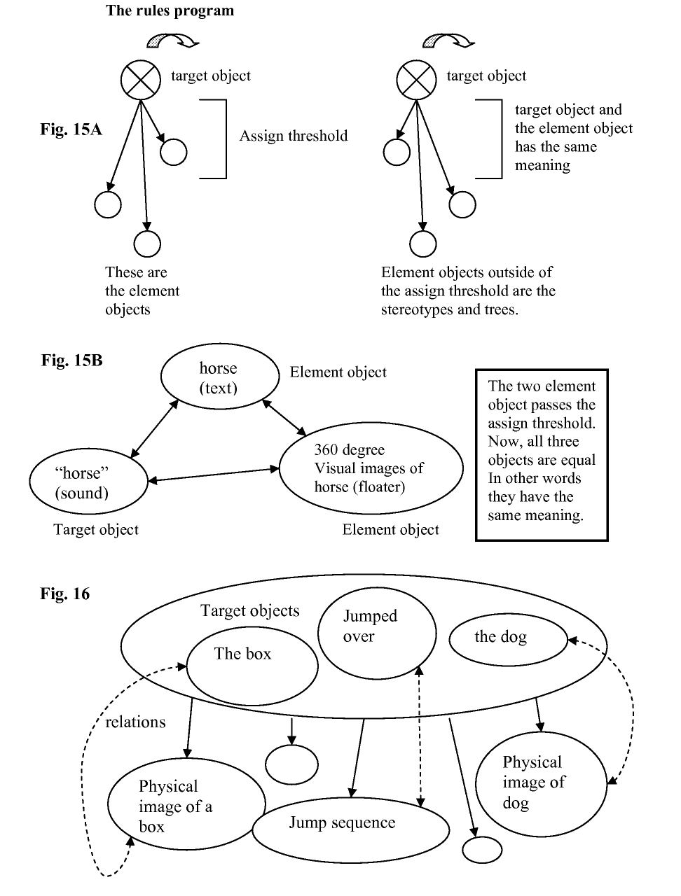

For each object the AI has to find other objects in memory that have association. “The more times two objects are trained together” and “the closer the timing of the two objects are” the more association the two objects have with one another. The object that will be used to find associations is called the target object and the objects that have associations are called element objects (FIG. 15A).

When the AI recognizes the target object from the environment it will activate closest element objects that have association to the target object. There are three types of element objects:
A. equals (same meaning)
B. stereotypes
C. trees

Equals

Objects that are very close to each other are considered “equal”. When any element object past the assign threshold the element object and the target object are considered equal—they have the same meaning. One example of this is the sound “horse”, if the sound “horse” is the target object and the element object that passes the assign threshold is a visual image of a horse then both the sound “horse” and the visual image of horse is considered the same (FIG. 15B).

Stereotypes

Stereotypes are facts about the target object. Objects that are associated with the target object but are not consistent are stereotypes. These objects are also farther away from the target object. We look at the fixed object as a part of the overall object. If the target object is “cat” and “cat” is a part of “cats don't like dogs”, then we can safely say that “cats don't like dogs” is a stereotype of “cat”.

Trees

Trees are objects that are usually farther away from the target object. Sometimes trees have relations to the target object. A tree is just instructions that people teach you at certain situations. Timing of the object is the key difference between stereotypes and trees. This is the most important trait in my program to convey intelligence. One example of trees is when you cross the street, the tree “look left, look right and check to make sure there are no cars before crossing the street” pops up in your mind.

To better understand about the rules program I will explain how the HLAI learns language.

How Human Robots Interpret Language

When dealing with language there are many AI software that tries to represent language. Among the most popular categories are: language parsers, discrete mathematics, and semantic models. None of these fields (or a combination of them) can produce a machine that can fully understand language similar to human beings. Designing a machine that can learn language requires a lot of imagination and creativity. My design of how to represent language comes from two sources: Animation and videogames. Mostly videogames because that is where my key ideas come from.

Common sense knowledge using language is very hard to represent on a computer because it's “all or nothing”. Either the computer can understand the language similar to human beings or they don't understand the language at all. People who clean rooms for a living not only need knowledge about cleaning rooms but also common knowledge that humans have. Basic things like: if you drop something it falls to the ground, if you break the law you will go to jail, if you throw an egg it will fall and break, if you don't eat you will get hungry. These are basic knowledge that every human should know. Machines on the other hand has to be fed the knowledge manually, unless someone builds a learning machine similar to a human brain. Even universal learning programs like the neural network require programmers to manually feed the rules and data in order for it to work. Like I said it's “all or nothing”.

If there exist a robot janitor and the function of the robot janitor is to clean the house, what happens when it's mowing the lawn and it begins to rain? Common sense tells a real human to take shelter. However, in the case of the robot janitor, it doesn't know that it's raining, unless you program it to take shelter when it rains. Another example is what if the janitor accidentally drops food on the ground; does it know that the food is contaminated? This is why it is very important to build a machine that is similar to a human brain in order for it to do anything human. The only way to build such a machine is by making software that can understand language.

Language is important because the robot needs to learn things from a society. The only way that humans can communicate with robots is if they both have some form of common language so that both parties understand each other. People who speak English can understand each other because the grammar and words used can be understood by everyone. Think of language as the communication interface between human robots and human beings.

There are basically 3 things that the AI software has to represent in the language: objects, hidden objects, and time. I don't use English grammar because English grammar is a learned thing. These 3 things I mentioned are a better way to represent language. If you think of objects as nouns and hidden objects as verbs, then that is what I'm trying to represent.

Objects

One day when I was playing a game for playstation 2, I couldn't notice that the game was repeating itself over and over again. When the characters jumped the same images appeared on the screen. When the enemies attacked the same images appeared on the screen. These repeated images was what gave me the idea that I can treat all the images on the screen like image layers in photoshop. I can use patterns to find what sequences of images belong to what objects. When the 360 degree images of one object is formed then I can use a fixed noun to represent that object (I call this 360 degree image sequence a floater). For example, if I have the 360 degree floater for a hat I can assign the letters “hat” to the floater. If I have the 360 degree floater for a dog I can assign the letters “dog” to the floater. The image processor will dissect the image layers out and the AI program will determine what the sequential image layers are. This is done by averaging the data in memory—taking similar training data and analyzing what the medium is. When the averaging is finished the floater has a range of how “fuzzy” the object can be.

Things like cat, dog, hat, dave, computer, pencil, tv, book are objects that have set and defined boundaries. Things like hand, mall, united states, universe don't have set boundaries. Either it doesn't have set boundaries or they are encapsulated objects. One example is the foot, when does a foot begin and when does a foot end? Since a foot is a part of a leg it is considered an encapsulated object. Another example is mall, when does the mall end and when does it begin? Since there are many stores and roads and trees that represent the mall we can't say where the mall ends and begins. The answer is the computer will figure all this out by averaging the data in memory. Another thing is that some objects are so complex that you have to use sentences to represent what it is. The Universe is one example, when does the universe begin and end? The answer is we use complex intelligence in order to represent the meaning to the word “universe”.

Unfortunately, black and white drawings are preferred in utility patents so I decided not to use colored pictures of videogames. (In U.S. Provisional Application No. 60/909,437, all examples are demonstrated by videogames) Instead I decided to use black and white images of animated movies and comic strips to illustrate my point about objects, hidden objects and time.

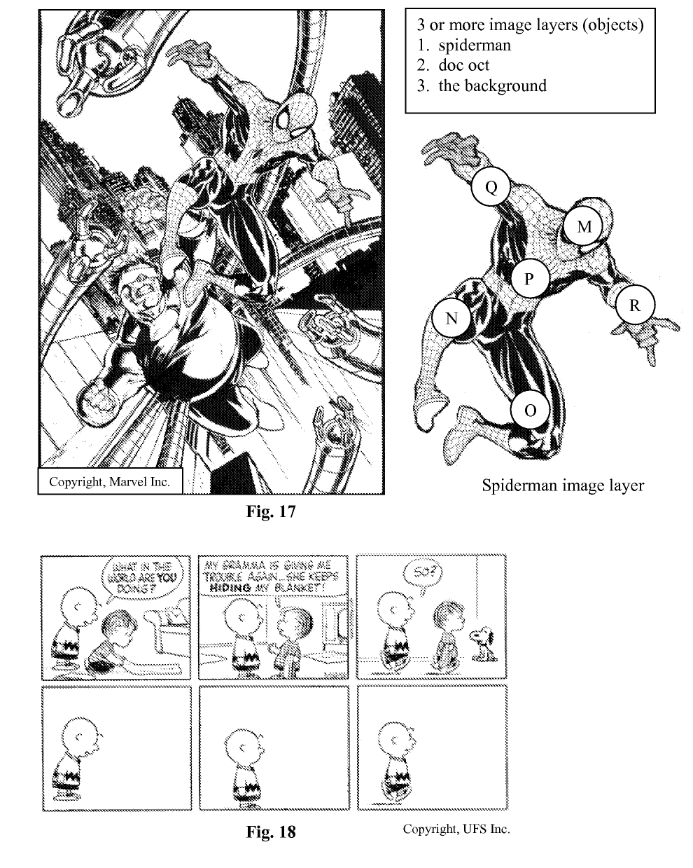

The first two pictures in (FIG. 17 and FIG. 18) best illustrate the point about image layers and floaters. The first picture displays a series of lines and shapes that make up images. There are many things that are displayed in the picture. There are: the moon, the city, the tentacles, the walls, the characters, the breakable objects and so forth. The image processor will dissect the most important image layers from the picture (this process can be done in black and white but the image processor will have an easier time with colored pictures). It will then attempt to find a copy of this image layer in memory. Based on certain patterns within all the colored pixels and the relationship between each other the AI will understand what image layers belong “sequentially”—consistency and repetition is the key. The computer will normalize all the image layers (including encapsulated image layers) until it comes to an agreement of what is considered an object and what are encapsulated objects. In (FIG. 17) is an example of 3 major image layers (objects) that the computer has found: Spiderman, Doc oct, and the background.

The purpose of the image processor is not to identify the image layers, but to delineate image layers that are moving from one frame to the next. The identification of the image layers comes by finding the image layers in memory. The image processor only makes the search process much easier to identify the image layers. One example is the Doc oct image layer. The image processor doesn't know that the tentacles belong to Doc oct. Infact, the image processor will think that the tentacles are separate image layers. Only when the AI identify Doc oct in memory does the AI know that the tentacles is a part of Doct oct.

Now that the image processor has found Spiderman as one image layer, it will randomly break up Spiderman further into partial data. This is represented by letters: M, N, O, P, Q, R. The partial data will each be searched randomly in the network.

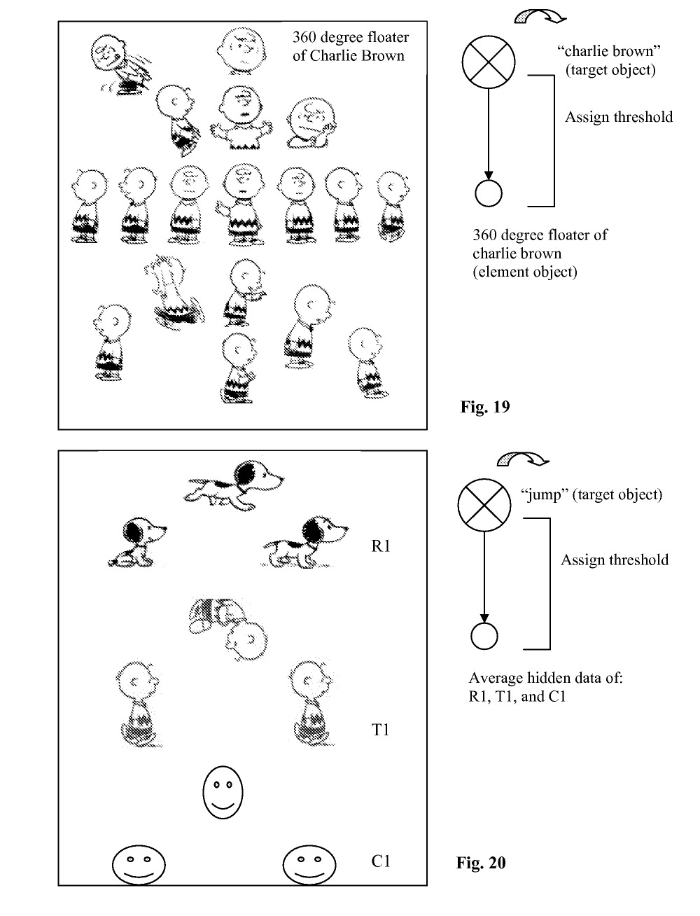

Although I couldn't find comic strips for Spiderman I found comic strips for Charlie Brown instead. In (FIG. 18) the image layers of Charlie Brown are cut out from the movie animation. On the second picture (FIG. 19) is the 360 degree floater of Charlie Brown (character). All the possible moves of the character including scaling and rotation are stored as sequences in this floater. If the movie sequence is in 360 degree, like in a videogame, then the floater will have 360 degree image layer for each possible outcome. If the movie sequence is in 2-d then the floater will have only possible outcomes of the character. “The creation of the floater is kind of like reverse engineering a videogame programmers work or reverse engineering an animators work—what do videogame programmers consider an object or what are the animators' cell layers”.

The next step is to take the floater and treat it as an object. This is how I represent objects visually in my program—by using patterns to find the 360 degree images of an object and all its possible moves. The rules program will bring the object “Charlie Brown” and the floater of Charlie Brown together (FIG. 19). The target object is the word “Charlie Brown” and the floater is the element object. Once the floater passes the assign threshold that means the word “Charlie Brown” has the same meaning as the floater. At this point, any sequence wither its one frame or 300 frames of the floater is still considered the same object. You can stare at a table for hours but the table will still be a table. You can also walk around and stare at the table, the sequential images you see is still a table. The question people ask is: what happens if you break the table or what happens if there are other objects that make up a table. The answer is the AI will normalize the objects and output the most likely identification.

There are other topics that concern objects such as encapsulated objects (a human object can have thousands of encapsulated objects) and priority of objects and partially missing objects but I won't get into those topics.

Hidden Objects

Sometimes there are objects that don't have any physical characteristics. Action words are things that don't have physical characteristics. Things like walking, talking, jumping, running, throwing, go, towards, under, over, above, until, and so forth. These words are considered hidden objects because there is no image, sound, taste, or touch object that can represent them. The only way to represent these objects is through hidden data that is set up by the 5 senses. Let's call the 5 senses the current pathway—the pathway that the computer is experiencing. In order to illustrate this point I will only refer to the visual part of the current pathway.

Within the visual movie are hidden data that I have set up. This is done because I wanted the computer to find patterns within visual movies. Some of these hidden data are: the distance between pixel/s and the relationship between one image layer and another image layer. Let's illustrate this point by using a simple word: jump. The computer will take several training examples from the visual movie regarding jump sequences. As you already know, variation to a jump sequence can range exponentially. A person can jump from the front, back, side, at an angle, top, 10 feet away, or 100 yards away. The person doing the jumping can be other objects such as a dog, rat, horse, or even a box. There are literally infinite ways that the jump sequence can be represented in our environment. The computer will take all the similar training examples and average the hidden data out. Every time that a hidden data is repeated the computer makes that hidden data stronger (hidden data are considered objects). The hidden data are also encapsulated so that groups of common hidden data are combined into one object. As more and more training are done the computer will have the same hidden data for the same fixed word: jump. The rules program will bring the word “jump” and the hidden data closer to one another. When it passes the assign threshold the word “jump” will be assigned the meaning (hidden data).

In (FIG. 20) the picture is an example of how the word jump is assigned a meaning. First, the computer analyzes each jump sequence: R1, T1 and C1. It will analyze all the hidden data that all three jump sequences have and group those common traits into an object. Then the rules program will take the word “jump” and assign it to the closest meaning.

The rules program is another thing I want to mention. When you train the robot, timing of the training is crucial. The reason why the word jump is associated with the jump sequence is because the jump sequence happens and either during the jump sequence or closely timed is the word “jump”. The close training of the word jump and the jump sequence is what brings the two together. If the word “jump” is experienced and the jump sequence happens 2 hours later, the computer will not know that there is a relationship between the word “jump” and the jump sequence. This is how the machine will learn language, by analyzing closely timed objects. This is also a way to rule out coincidences and things that happen only once or twice.

Time

Time is another subject matter that has to be represented in terms of language. In my program there is no such thing as 1 second, 1 minute, 5 years, or 2 centuries. The time that we know are learned time and isn't used in my program. What I have done is create an internal timer that will run infinitely at intervals of 1 millisecond. The AI will use this internal clock and try to find if there are objects (words) that have relationships to the internal clock. The timing in the AI clock can also be considered an object. For example, if someone says “1 second”. After many training examples the computer will find a pattern between “1 second” and 100 milliseconds in the AI's internal clock. This internal clock of 100 milliseconds will be an object that has the same meaning as “1 second”.

The above information concludes how my program represents things like nouns, verbs, time, and grammar. When we are dealing with entire sentences the computer has to do all the hard work by averaging all the training examples, looking for patterns, and assigning meaning to words in the sentence. The sentence itself is considered a fixed movie sequence while the meaning to the sentence changes as the robot learns more In (FIG. 16) the diagram gives an example of how the rules program will assign meaning to the sentence “the box jumped over the dog”. Just like how the rules program learn nouns and verbs, it will learn the meaning of the sentence by finding the “complex patterns”. The target object is broken up into sub-groups and the element objects are broken up into sub-groups. The AI will then attempt to string the element objects and combine them into other element objects that best represent the entire sentence.

This type of machine to represent language is considered “universal” because the program can be applied to all languages including sign language. Different languages use different words to represent the same things. “cat” in English, “neko” in Japanese, and “mau” in Chinese are all talking about the same object. Different verbs in English, German, or Latin are all talking about the same verbs. Even something like sign language uses fixed sequential hand motion to represent words and phrases. The grammar too also relies on patterns and different ways of stringing words/verbs together to mean something. This is easily done with the AI program because finding patterns is what it was designed to do. As long as the grammar in that language repeats itself or have some kind of rule (regardless of how complex) then the pattern will be recognized by the AI.

Patterns and Language

Now that I have discussed all the basics of how most words are represented let's get into something more complex such as finding patterns. When a question like: where is the bathroom? is asked, patterns are used to answer the question. These patterns are found by averaging similar pathways in memory. Some of the functions used to find patterns include: using the 3-d environment (in storage), using visual functions such as pixel comparison and image layer comparison, using long-term memory, searching for specific data in memory, and so forth. Where is the book, where is the sofa, where is Mcdonalds, where is the University, where is dave? All these questions rely on their respective universal question-answer pathway. The AI will look into memory and find out that there is a relationship between a question and a specific type of pattern to get an answer. In terms of the bathroom question, the AI will find that it has to know where it is located presently (this is done by looking around and identifying its current location). Then the robot will look into memory for the bathroom that is located in the current location. If the bathroom location is found in memory it will output the answer: “the bathroom is located - - - ”. If it doesn't know (no bathroom memory in current location) it will either say it doesn't know or it will attempt to find more information to answer the question.

This pattern finding doesn't just apply to questions and answers but also statements and orders. If someone said: “remember to buy cheese at the supermarket”. This statement has a recurring pattern and it requires that there are many training examples so that the AI can find these patterns. The pattern is when the robot gets to the supermarket, sometime during the purchase of goods, the statement pops up in memory “remember to buy cheese”. Sometimes the robot forgets (either a learned thing or the pattern wasn't trained properly).

The data in memory will become stronger and stronger as more training is presented. Language or sentences are considered data in memory. These type of data will become considerable stronger than other data because language is fixed while other things constantly change. Language is what humans use to classify other data in our environment which includes visual objects, nouns, verbs, sentences, scenes, description, tasks, and the like. In other words, language brings order to chaos. This is why when we take input from the environment language has top priority over other data. This is also why our conscious activates sentences and visual scenes more than anything else when we consciously think.

The AI will average all the data in memory and create a fuzzy range of itself called a floater. Data in memory would include images, objects, pathways, entire scenes, and so forth. Averaging of data (or self-organizing of data) takes place when input is stored in memory. After the averaging, a fuzzy range of the data will be the result. In terms of sentences the average meaning of the sentence will be stored and not an exact sentence.

A. Averaging the meaning of sentences

When teachers say:

(R1) “look left, right, and make sure there are no cars before crossing the street” (R2) “remember to see if there are no cars from the left and right before you cross the street” (R3) “don't forget to look at all corners to make sure there are no cars before crossing the street”
All the sentences are saying the same thing. This is why language is so important, we can interpret language infinite ways and they are all talking about the same things. The computer will recognize all of these things and it will average out what the meaning of the sentence is

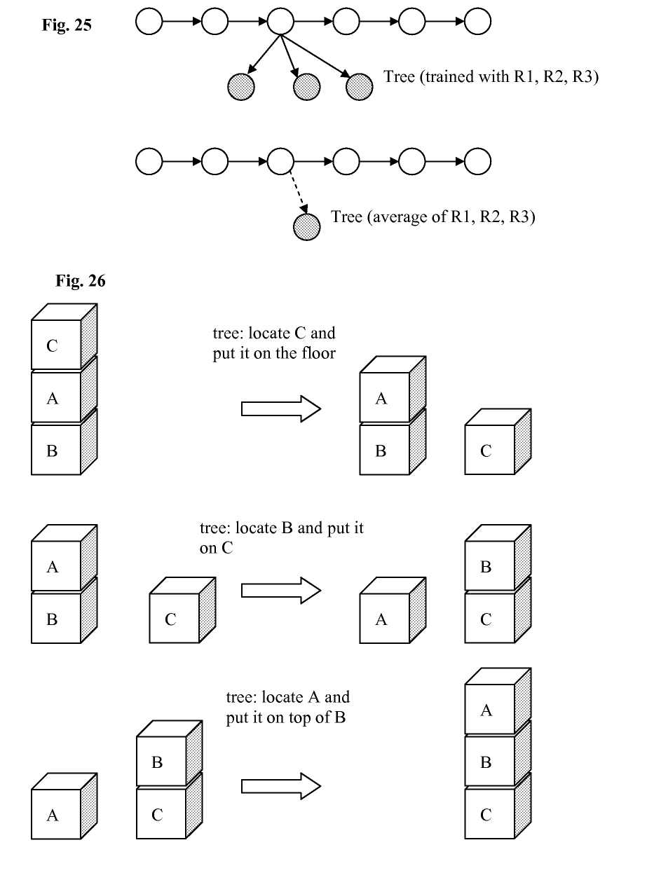

After many training of the pathway the AI has universalized the groups of pathways (R1, R2, R3). R1, R2, and R3 disappear and what you have left is the average of all the training data located in that area (FIG. 25).

The AI not only averages out trees in pathways but entire pathways. The purpose is to universalize similar pathways into one pathway. This one pathway will contain the fuzziness of infinite possibilities. We can also take this universalized pathway and encapsulate that to make even more complex pathways.

The next two examples illustrate how language can be incorporated into the human conscious to accomplish tasks and solve problems.
A. ABC block
B. Answering universal questions

ABC Block

In this problem we want to use a basic intelligent problem that kids can solve. The ABC block is just 3 square blocks and the robot has to find a way to stack the blocks in an A B C format.

We accomplish this problem with the English language. We simple tell the machine: “I want you to stack the blocks up starting with C then B and finally A”. From this one sentence the robot should be able to finish the task. It doesn't matter what order the blocks are put in. It doesn't matter where the blocks are. If the robot understands the sentence it will carry out the command. Of course we have to train it to understand the steps to accomplishing this easy task. Let's say that we had the blocks in this order and we wanted the robot to stack the blocks up from ABC (in FIG. 26)

We learned from teachers that in order to solve this problem we: “locate the C block”, “Take the C block and put it on the ground”, “then find the B block and put it on the C block”, “finally find the A block and put it on the B block”. These sentences are trees that tell you what to do in order to solve this problem. These trees were trained by a teacher many times before you can attempt to solve this problem. By the way, these trees are your conscious (FIG. 26).

These trees encapsulate the instructions to accomplish a goal. We train them by teaching the robot that this sentence is followed by these instructions. The robot will create pathways in memory that will store the instructions step by step. This may not sound impressive but let's say you wanted to solve something like lining up the entire alphabet letters in a certain order. If you preprogram the solutions there will be couple trillion possibilities you have to manually preprogram. With trees we can encapsulate instructions in the form of sentences. And these sentences can be encapsulated into even more complex problems, thus making a complex problem into a simple problem.

### Answering Universal Questions

The answering of questions relies on patterns in order to be understood. We are able to find the patterns and universalize the pathways so that when someone ask us a question we can give them the appropriate answer.

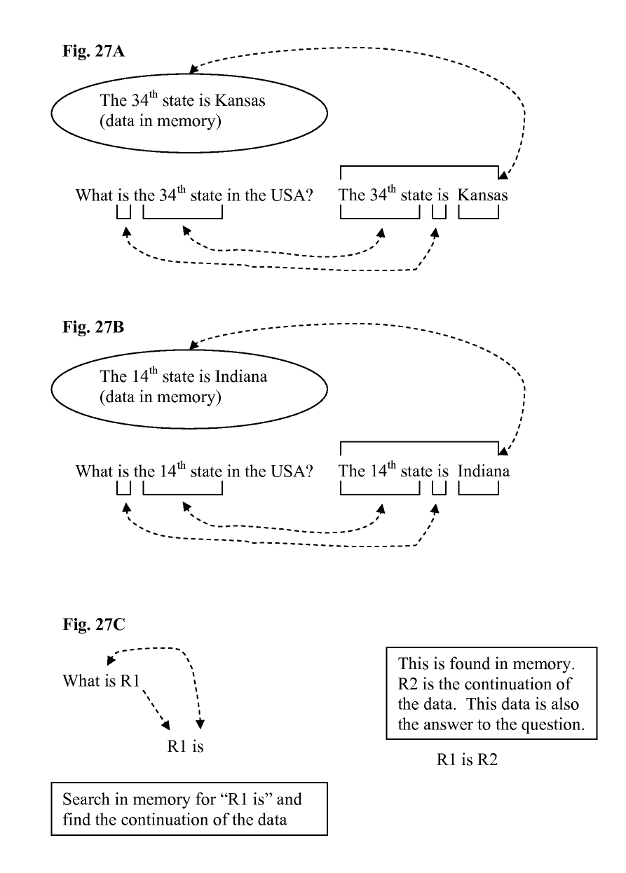

8=8 is an equal object or Dave=Dave is an equal object. They are equal is the relationship between the two objects. Whenever the computer finds two objects equal it will establish a relationship between the two objects and find patterns that revolve around these two objects. From (FIG. 27A-27C) we have taken all the equal objects and we have tried to find patterns between those equal objects. Answering questions is a pattern that relies on equality to find the answers. This may not be very clear when you look at the first example, but after looking at the second example and comparing that with the first example there is clearly a pattern there.

By establishing a relationship between equal objects the computer will be able to find patterns between different training data and forge a universal pattern that can answer a universal question. The examples in (FIG. 27A and FIG. 27B) have a pattern which is depicted in (FIG. 27C).

The pattern found in (FIG. 27C) can answer any question that has that kind of configuration. Examples of this would be:

what is 8+8? 8+8 is 16.
what is the 21st state in the USA? The 21st state in the USA is Illinois.
what is the first letter in the alphabets? The first letter in the alphabets is ‘A’
what is the last letter in the alphabets? The last letter in the alphabets is ‘Z’

As you can notice that this whole human level artificial intelligence program is all about finding patterns. I set up the different kind of patterns to look for and the computer uses the AI program to find those patterns and assign those patterns to language. Language will always be fixed (unless society changes it) but the patterns that represent language changes from one time period to the next. There are also multiple meaning to fixed words.

The Relationship Between HLAI and the Human Brain

The data structure of a human brain and something like a calculator are totally different. On one hand a calculator can process thousands of equations each second but the human brain processes only 1 equation per second. This doesn't mean that the calculator is more superior than a human brain. It just means that the brain is a different form of computer that processes information differently. The human brain is a very powerful computer that can learn from past experiences and understand common sense knowledge which is something current computers can't do.

The human brain consists of 10 billion neurons and 60 trillion connections. The data are stored in the neurons in terms of encapsulation and commonality. Although the brain has only 10 billion neurons it is able to store almost 8,000 trillion data because of the connections that each neuron has with other neurons. The data are also global in nature and each neuron will have associations with other neurons. All of the neurons and their connections are either strengthened or forgotten. The neurons get strengthened by a process of chemical electricity that makes their connections with other neurons stronger (or weaker).

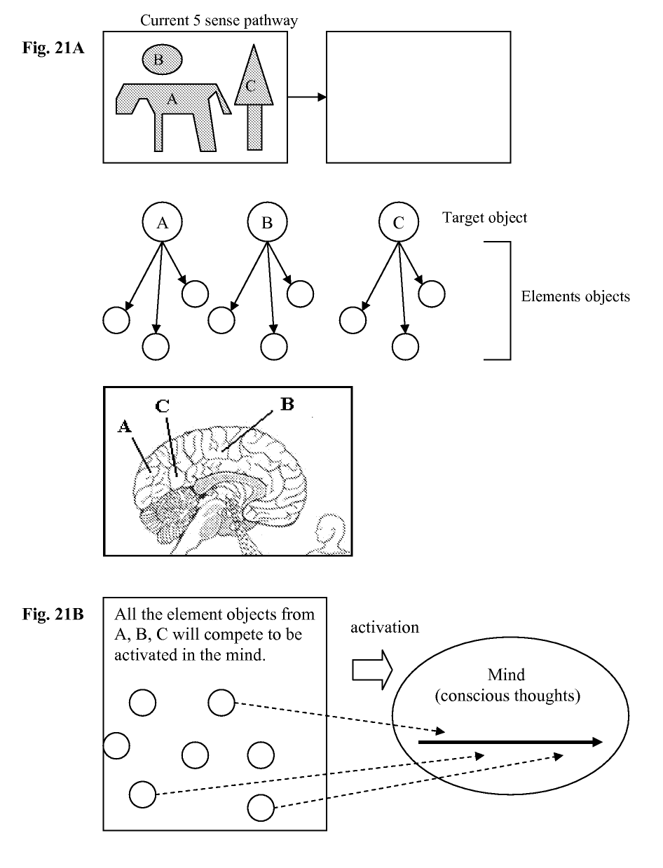

When an object is recognized like an image or a sound, electricity is run through that neuron and its connections (FIG. 21A). This is how psychologists can understand what parts of the brain does what functions—by using a computer to analyze the electrical activities in the brain. Since there are many sensations coming into our brain each second, there isn't just one area the brain is active but activity will run in multiple areas of the brain at the same time.

I did some observation of how the brain sends electricity throughout the neurons and came to the conclusion that we can actually simulate this activity in a software. First the brain locates an object (let's call this object the target object). In this case an object could be anything—it can be an image of a car or a sound of a dog barking. Once the brain locates the target object in memory it runs electricity throughout all of the connections associated with that object. This will strengthen not only the target object that has been located but it will bring all the other objects (call these element objects) closer to the target object.

When the AI locates the three visual objects: A, B, C in memory it will run electricity through these nodes and all of its connections (FIG. 21A).

The mind has a fixed timeline. Only one element object can be activated at a given time in this timeline. This is how we prevent too much information from being processed and allow the AI to focus on the things that it senses from the 5 senses (FIG. 21B).

This finding is important because we know that the target object that the brain has located has to be strengthened. This is done by applying chemical electricity through that located target object. The only question I had was: “why did the electricity propagate throughout all of its connections too?”. Would that not strengthen all the element objects around the target object too?

The reason why the brain had to propagate electricity throughout all of the target object's connections is because that is how the conscious is presented. The conscious is the voice in your head that speaks to you. It also gives you information about a situation, or help you solve a problem, or tell you definition of words (FIG. 21B). All the element objects from all the target objects will compete with one another to activate in the mind (the mind can only take in a limited amount of information). When that information is activated in the mind a lesser amount of electricity will be applied to that information and its connections. This is how the mind travels from one subject matter to the next.

The brain modifies information by constantly applying chemical electricity throughout all the target objects coming in from the 5 senses. The electricity strengthens not only that target object but it strengthens all the element objects that have association with the target object. This form of storing, retrieving, and modifying information in a network is what allows the host to have human-level intelligence. The next two paragraphs demonstrate how the conscious works in terms of reasoning and interpreting grammar.

Reasoning happens when two or more objects recognized by the AI share the same element objects. The more objects share an element object the better the chance it will get activated. For example, if you had a statement like:

If the weather is sunny and I have free time and my dog is blue then go to the beach.

So, if the AI recognizes “the weather is sunny” and “I have free time” and “my dog is blue” then the stereotype will activate: “then go to the beach”. The recognizing of the objects can also be in any order. These objects can also be a fuzzy range of itself such as the statement: “I have free time” can be represented as “I don't have to work today”.

Understanding entire sentences, which was discussed earlier, depend greatly on the conscious. Understanding grammar structure of a language will depend on things learned in the past (FIG. 5). For example, how are we supposed to learn a word like: jumped. The word jumped has an ed at the end and we know from English classes that if a word has ed at the end that means the verb (ump) happened already. So, when the AI encounters a word like jumped the conscious tells the AI that “words with ed at the end means the jump happened”. This is an element object that activated when encountering the word jumped. This element object tells the AI what the meaning of jumped is.

Predicting the Future

The main function of the HLAI is to predict the future based on the current event. When the AI is applied to a car the current driving state is the current event. The AI has to predict the future so that it can steer the car in the right direction. Out of all the pathways in memory the machine can only follow one given pathway, the optimal pathway. This optimal pathway represents the best pathway the AI can follow to act intelligently in the future. Predicting the future isn't a very easy thing to do. In order to do that the AI must first determine the worth of each pathway in memory based on two criterias: the closest pathway matches and calculating the worth of their future pathways.

The next couple of paragraphs are a recap of how the AI program predicts the future. In (FIG. 1) the program has one for-loop that repeats itself over and over again. The idea is: The computer takes in one frame from the camera, it calculates the best possible future to take, then it takes action. The computer takes in one frame from the camera, it calculates the best possible future to take, then it takes action. The computer takes in one frame from the camera, it calculates the best possible future to take, then it takes action. This loop repeats itself over and over again until the AI is shut down (the instructions in the for-loop must be accomplished within a predefined time limit, usually 1 millisecond). Human beings work pretty much the same way, we take in input from the environment, the brain calculates the best future course, then the human being takes action. This repeats itself over and over again.

In (FIG. 1), the first step is to search the current pathway in memory for the closest matches. The computer will list the ranks of the searches starting with the best match. Next the AI will find future pathways for each of the matches and calculate their future prediction worth. Then, the AI will decide based on the matches and the future prediction on which pathway is worth the most. Finally, the AI chooses one pathway to follow. This one pathway is the optimal pathway and it will be used to control the AI.

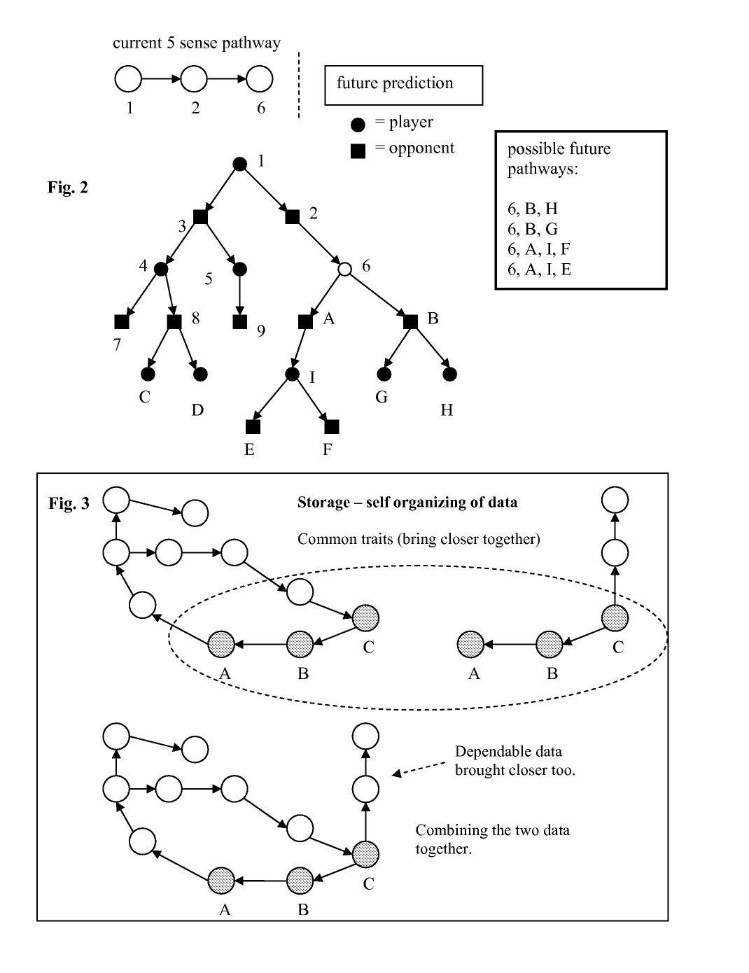

In (FIG. 2), I show how the function works from a different angle. The computer basically matches the current pathway with the best match in memory then it calculates the best possible future to take.

This form of artificial intelligence method to predict the future has not been explored before because the possible outcome of an event in life is infinite and the computer can't store all the possibilities in memory. In order to drive a car the AI has to store all the possibilities of driving a car in memory. This would be impossible because the variations of life are infinite (can you imagine storing infinite hours of driving in memory?). This is why researchers have abandoned this field of AI. In my program I made it so that the movie sequences are stored in a fuzzy logic way. The most important data are kept and the least important data are forgotten. This will allow the AI to anticipate the most likely outcome of an event. Self-organization knits all the data together forming object floaters in memory so that one given data has a fuzzy range of itself. One example is a cat. A cat can come in all different kinds of shape, sizes, and color. The strongest sequential images of a cat are considered the center of the object (floater). After determining a predefined range of how fuzzy the cat object (floater) can be, anything that falls within this fuzzy range will still be considered a cat object. The AI will be able to take in any picture of a cat, regardless of how distorted or different it may be, and still identify it as a cat. This is how my program can store infinite amounts of data, by taking the average of an object and creating a fuzzy range for that object. Object floaters don't just apply to individual objects like cat, dog, or shoe, but entire situations or language. Every data in memory has a fuzzy range of itself. The next several paragraphs demonstrate how fuzzy logic is used to predict the future for similar or non-existing pathways in memory.

When my computer program doesn't find a 100 percent match in memory the AI has encountered a deviation (finding a 100 percent match is very rare). There are 4 deviation functions I have set up to solve this problem. It will allow the future prediction to do its job properly and find the most likely next step. I will be using videogames to illustrate this point. Videogame colored pictures can't be used so the images will be done with animated movies. The 4 deviation functions are:
A. Fabricate the future pathway based on minus layers.
B. Fabricate the future pathway based on similar layers.
C. Fabricate the future pathway based on sections in memory.
D Fabricate the future pathway based on trial and error.

Fabricate the Future Pathway Based on Minus Layers

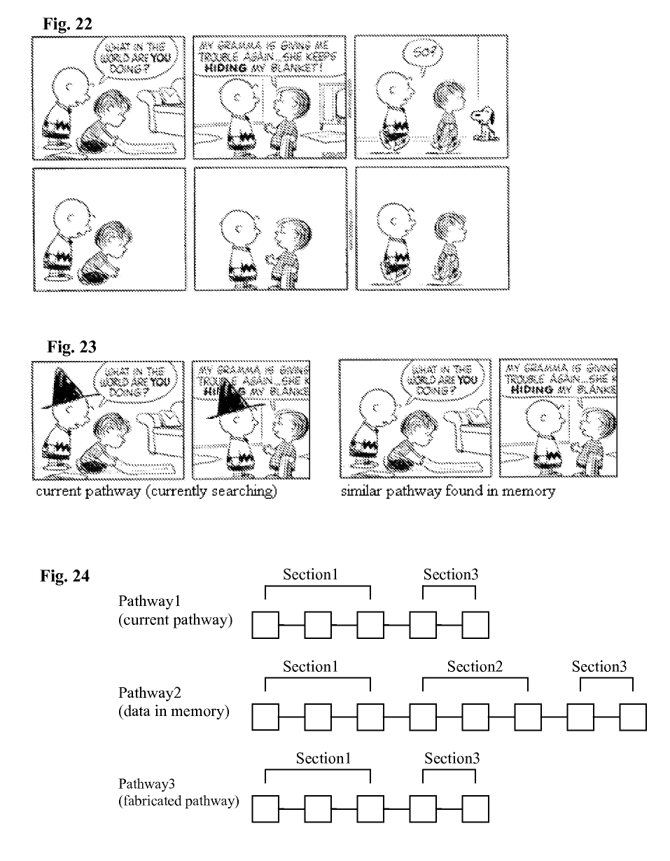

In (FIG. 22) the AI minuses layers from the pathways and finds the commonalities between the current pathway and the pathways in memory. For videogames/animation the AI minus object layers from the game. The background layer is minused from the game and the remaining layers matches the current pathway. This means the sofa, the blanket, the walls, snoopy, and the captions are minused. The two character layers (Charlie Brown and his friend) are used to play the game.

Fabricate the Future Pathway Based on Similar Layers

In (FIG. 23) the AI will find similar layers between the current pathway and pathways in memory. For videogames/animation the AI finds similar object layers. The Charlie brown layer with the hat isn't stored in memory. However there is a similar Charlie brown layer without the hat stored in memory. Because the Charlie Brown layer with the hat and the Charlie Brown layer without the hat look similar the computer will use the Charlie Brown layer without the hat instead of the Charlie Brown with the hat to play the game.

Fabricate the Future Pathway Based on Sections in Memory

In (FIG. 24) the AI constructs new pathways from sections in memory. This process takes sections of pathways from memory and combines them to form new pathways for the AI to pick. Pathway1 is the pathway it is looking for in memory. However, there is no 100 percent match in memory. The closest match is pathway2. It takes section1 and section3 from pathway2 and fabricate pathway3. This fabricated pathway will be used to play the game.

Fabricate the future pathway based on trial and error

The AI plots the strongest future state and fabricates a pathway to get to that future state using the other deviation functions.

With all 4 deviation function the AI program can fabricate pathways in memory if there are no exact matches found. All four deviation functions create the fuzzy logic of the system. It acts by giving the AI alternative pathways if an exact match isn't found in memory. It also gives the AI the ability to predict the future of pathways that are similar or non-existing in memory.

For future predictions, the weights of future sequences in the pathway has already been established by training and only require the AI to predict 3-4 steps into the future to receive an accurate prediction of thousands of steps into the future. In some cases future prediction isn't required because of this system to store/retrieve and modify information (FIG. 14).

The steps to calculating the worth of future pathways are: designating a current state in a given pathway and determining all the future sequences in the pathway; adding all the weights for each possible future sequences; calculating the total worth of each possible future pathway and ranking them starting with the strongest long-term future pathway.

Long Term Memory

One other subject matter I will discuss is long-term memory. Long-term memory is just one long computer log of sequential movie events collected by the AI. The long-term memory is actually a timeline with references to sequential data collected by the AI (in increments of 1 millisecond). When the data in the network is forgotten the data in long-term memory is also forgotten. However, the forget rate isn't as smooth and linear as a straight line. The remembering of data is based on emotional factors, pain or pleasure, the AI's intelligence level, and other innate factors such as attractiveness or ugliness. Memory will be forgotten centered at the current state; the farther the data is from the current state the more it forgets. This doesn't mean that data 10 years ago is less clear than data 1 week ago. Sometimes data that happened 10 years ago is stronger than data that happened 1 week ago because the AI has a strong recollection of an event or that data is being recalled many times by the AI.

Finding patterns is the single most important trait used to produce human level artificial intelligence. The long-term memory is used in the pattern finding process. The 3-d storage and the 3-d environment are also used in the pattern finding process; along with thousands of other embedded data or functions. This part of the program is very complex and long and is beyond the scope of this present invention. The most important patterns are disclosed in this patent.

The long-term memory has embedded data in it to help the AI find patterns. Having the ability to rewind and fast forward movie sequences to find information is a valuable asset. For example, if someone wanted to know when the AI machine saw a car accident, the machine will use the long-term memory to locate the time it saw the car accident. If someone wanted to know how long it took the machine to finish a task the machine will locate the movie sequence that contain the task and give an approximate time it took to finish the task.

The 3-d storage which maps out a 3-d environment has embedded data in it to help the AI find patterns. For example, if someone wanted to know where the closest Mcdonalds is in a city, the machine has to look in the 3-d environment (3-d storage) and locate where the city is and the closest Mcdonalds is. If someone wanted to know the approximate distance from one location is to another location, the machine will use the 3-d environment to find the approximate distance.

All these patterns are found on its own through observation and learning. No fixed rules or policies are needed to learn how to do things. Answering questions is learned on its own, finding out solutions to problems are learned on its own, learning the rules of driving a car is learned on its own, and so forth. There are no predefined rules to tell the AI what to do and what not to do, everything is learned from society.

The foregoing has outlined, in general, the physical aspects of the invention and is to serve as an aid to better understanding the intended use and application of the invention. In reference to such, there is to be a clear understanding that the present invention is not limited to the method or detail of construction, fabrication, material, or application of use described and illustrated herein. Any other variation of fabrication, use, or application should be considered apparent as an alternative embodiment of the present invention.

What is claimed is:

1. A method of creating human level artificial intelligence in machines and computer based software applications, the method comprising:
an artificial intelligent computer program repeats itself in a single for-loop to receive information, calculate an optimal pathway from memory, and taking action;
a storage area to store all data received by said artificial intelligent program; and
a long-term memory used by said artificial intelligent program.

2. A method of claim 1, wherein said for-loop contain instructions that said artificial intelligent program must accomplish within a predefined fixed time limit, for example, 1 millisecond, 10 millisecond, 86 millisecond, instructions in said for-loop comprising the steps of:
entering said for-loop;
receiving input from the environment in a frame by frame format or movie sequence, each frame containing at least one data comprising of at least one of the following senses: sight, sound, taste, touch, smell or a combination of senses;
searching for said input in memory and finding the closest matches;
calculating the future pathway of the matches found in memory and determining the optimal pathway to follow;
storing said input in the optimal pathway and self-organizing said input with the data in a computer storage area called memory;
following the future pathway of the optimal pathway and exiting said for-loop; and
repeating said for-loop from the beginning.

3. The method of claim 2, wherein searching for information is based on searching for one pathway in memory, which is referred to as the optimal pathway, and said artificial intelligent program will take action by following the optimal pathway's future pathway

4. The method of claim 2, wherein searching for the input in memory, the input called the current pathway, the method comprising the steps of:
using an image processor to break up said current pathway into sections of data, called partial data;
searching for each of the partial data in memory using randomly spaced out search points;
each search point will collaborate and communicate their search results with other search points to converge on the pathways that best match said current pathway until the entire network is searched.

5. The method of claim 4, wherein each search point will communicate with other search points on search results with at least one of the following: successful searches, failed searches, best possible searches and unlikely possible searches.

6. The method of claim 4, wherein each search point has a priority number, and determining said priority number comprises of at least one of these criteria:
the more search points that merge into one search point the higher said priority number;
the more matches found by the search point the higher said priority number; and
the more search points surrounding that search point the higher said priority number.

7. The method of claim 6, wherein the higher said priority number the more computer processing time is devoted in that search point and the lower said priority number the less computer processing time is devoted in that search point.

8. The method of claim 3, wherein if the search function doesn't find an exact match in memory said artificial intelligent program will attempt to fabricate pathways and fabricate future pathways by using at least one of the four deviation functions: fabricating pathways using minus layer pathways, fabricating pathways using similar pathways, fabricating pathways using sections in memory, and fabricating pathways using the trial and error function.

9. The method of claim 2, wherein calculating the future pathways comprises:
designating a current state in a given pathway and determining all the future sequences in said pathway;
adding all the weights for each possible future sequences;
calculating the total worth of each possible future pathway and ranking them starting with the strongest long-term future pathway.

10. The method of claim 1, in which the storage of data is based on a network contained in a 3-dimensional grid, said data being represented by objects comprising of at least one of the following: visual images, sound, taste, touch, smell, math equations, or combination of objects.

11. The method of claim 10, wherein the 3-dimensional grid stores at least one data structured tree, each tree can grow or shrink in size based on the amount of training, and each tree can break apart into a plurality of sub-tree branches when data is forgotten.

12. The method of claim 10, in which the storage space uses a 3-dimensional grid to contain all the pathways from input; and each pathway is subject to space in the 3-dimensional grid where 2 data can not occupy the same space at the same time.

13. The method of claim 10, wherein during self-organization in the 3-dimensional grid said artificial intelligent program will designate a given radius, centered on the input data, to bring common groups closer together; data outside of said radius will not be affected while data in said radius will be subject to changes.

14. The method of claim 10, wherein each data comprises two types of connections with other data in memory and are independent of each other:
sequential connections, which is best represented as a frame by frame movie; and
encapsulated connections which are objects that are contained in another object, for example, pixels are encapsulated in images, images are encapsulated in movie sequences, and movie sequences are encapsulated in other movie sequences.

15. The method of claim 14, in which the sequential connections are used for predicting the future while the encapsulated connections are used for storing and retrieving data from memory.

16. The method of claim 2, wherein self-organizing of data, also known as the rules program, finds association between objects in memory, the method comprising the steps of:
designating an object from input as a target object;
searching and identifying said target object in memory;
designating the objects surrounding said target object in memory and the objects surrounding said target object in the input space as the element objects; and
bringing the element objects closer to said target object based on association.

17. The method of claim 16, wherein the association between target object and the element object further comprising:
the more times the target object and the element object are trained together the stronger the association; and
the closer the timing of the target object and the element object are the stronger the association.

18. The method of claim 16, in which said artificial intelligent program will use the rules program to create the human conscious, the method comprising the steps of:
searching and identifying target objects from input;
gather all the closest element objects from all the target objects found in memory;
determining which element objects will be activated; and
activating each of the qualified element objects in linear order.

19. The method of claim 18, wherein activating element objects will result in conscious thoughts equivalent to human beings, said conscious thoughts being represented by instructions, in the form of language or visual images, that will guide said artificial intelligent program to execute at least one of the following: solve arbitrary problems, provide meaning to language, give information about an object, and provide general knowledge about a situation.

20. The method of claim 16, wherein meaning of objects, most notably meaning to language, occurs when two or more objects fall within the same assign threshold, for example, a sound of cat, the visual text cat, and the visual floater of cat are stationed in the same assign threshold, therefore all three objects have the same meaning.

21. The method of claim 16, wherein self-organization of data comprises two types of groups: learned groups; and commonality groups.

22. The method of claim 21, wherein said commonality group is represented by any 5 sense traits or hidden data that two or more objects have in common such as common traits represented by sight, sound, taste, touch, smell or hidden data set up by the programmer within these 5 senses.

23. The method of claim 21, wherein said learned group is represented by two or more objects that have strong association to one another; particularly two or more objects that are stationed in the same assign threshold.

24. The method in claim 10, wherein the 3-dimensional storage grid uses the 2-dimensional movie frames and store them in such a way that said 2-dimensional movie frames produces a 3-dimensional environment.

25. A method to mimic long-term memory similar to human beings in claim 2, the method comprising:
a timeline, with increments of 1 millisecond, that contain reference points to the time movie sequences occurred;
said timeline has reference pointers to movie sequences stored in memory; and
said artificial intelligent program uses said timeline to find patterns to intelligence and conscious thought.

26. A method to create an N-dimensional object from 2-dimensional sequential movie frames, said N-dimensional being represented as any-dimensional, the method comprising the steps of:
using an image processor to delineate moving or non-moving image layers from one frame to the next in said 2-dimensional movie;
using the self-organization technique in said artificial intelligent program to find repeated patterns based on colored pixels from frame to frame;
determining what image layers belong sequentially from frame to frame and designating the strongest sequential image layers as the center of said N-dimensional object; and
determining a predefined range of how fuzzy said N-dimensional object can be and anything that falls within this fuzzy range will be considered said N-dimensional object.
